(19) United States
(12) Patent Application Publication
(10) Pub. No.: US 2004/0267580 A1
(43) Pub. Date: Dec. 30, 2004

(54) Consolidating engine for passengers of private aircraft

(76) Inventor: Ian Saul Becker, San Diego, CA (US)

Correspondence Address: Ian S. Becker, PO Box 370831, San Diego, CA, 92137-0831, US

(21) Appl. No.: 10/844,175

(22) Filed: May 12, 2004

Related U.S. Application Data
(60) Provisional application No. 60/482,841, filed on Jun. 26, 2003.

(51) Int. Cl. G06F 17/60

(52) U.S. Cl. 705/5

(57) ABSTRACT

A system and method is disclosed, which facilitates the consolidation of users, automatically via an interactive media, so as to share a desired commodity with the intended purpose of reducing the cost-of-use to each user. More specifically, individual passengers wanting to travel on a private aircraft, from a departure of their choice, to a destination of their choice, at a time and date of their choice, can, using this invention, share the costs of renting said aircraft among themselves. The specified needs of individual users for a designated commodity are received via computer, linked to a data base via an interactive media, such as the internet, then, is compared to that of other users. The system aggregates or consolidates the said needs of said users. The invention amortizes the cost of a said commodity among a plurality of users.

### CROSS-REFERNCE TO RELATED APPLICATIONS

This application claims priority to, and the benefit of U.S. Provisional Patent Application Ser. No. 60/482,841 entitled “System and method for consolidating passengers on charter flights: a consolidating engine” and filed on Jun. 26, 2003, which is hereby incorporated by reference in its entirety.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to a computer based automated system, that enables passengers to create an itinerary for travel on private aircraft. More specifically, this invention enables passengers to share the cost of said flight by consolidating their itineraries.

2. Discussion of Prior Art

The most common method of air travel is via commercial airlines.

Presently, commercial airlines service approximately 300 airports across the United States; flying to, and from about 30 hub airports. There are, in fact, more than 5,000 operational airports in the United States.

Commercial airline service is expensive in terms of time, productivity, and money.

Fares have risen dramatically in the last few years. Airlines have made significant cuts in the number of flights they offer. Their schedules are not guaranteed. Most routes are circuitous. Direct, non-stop routes are rare.

Passengers are often stranded because of these capricious schedules. This wrecks havoc with their travel plans.

Security check points, although necessary, are unfortunately time consuming. Consequently, time spent at airports is often longer than time spent actually flying.

The net result is, commercial airline passengers are frustrated and dissatisfied.

Private, or charter flights offer an alternative that is infinitely flexible, and productive. Because, by definition, they are on-demand, point-to-point, direct non-stop. J D Power & Associates reports that traveling by private plane can save frequent fliers a month of time annually.

Private flights operate to, and from, most of the 5,000, currently available, airports across the United States. By avoiding the major airports serviced by the commercial airlines, and by flying directly to an elected destination, private charter flights offer optimum efficiencies in terms of time and productivity. However, charter is only available by the entire aircraft. Charter presently does not offer a, by-the-seat fare arrangement.

Various methods exist to order, rent or book charter flights, in person, and on-line.

Prior art does not dwell on charter by individuals. Prior art does not offer a method or system whereby a plurality of passengers can independently charter the same aircraft for the purpose of sharing the costs.

Prior art does not address any method to reduce the cost of private air charter by sharing, consolidating or amortizing the passenger load.

Prior art does not offer any system, method, or solution to share private charter aircraft with other passengers.

Prior art does not facilitate consolidating, or aggregating a plurality of passengers' itineraries over a media such as the internet.

Because chartering, or renting is presently available only for the entire aircraft; it is prohibitively expensive.

An individual traveler wanting to fly directly from a designated departure point, to an elected destination has to rent, or charter the entire aircraft by themselves.

Therefore, the need arises for a means to open these private flights to more than one passenger at a time. More specifically, an easily accessible system and method whereby a plurality of passengers can independently create, and, arrange their own schedules or itinerary, and then, consolidate these unique schedules with other passengers for the purpose of sharing a charter, or rented aircraft, so as to reduce the cost per passenger.

The need arises for a method that enables individual passengers to share the costs of chartering, while administrating, and managing the details of the chartering process. The results would be: (a) private aircraft charter at a price comparable to commercial airline unrestricted fares, and, (b) avoiding the circuitous, time-wasting routing and, check-in procedures of the commercial airline paradigm.

There is a need for a point-to-point, affordable, by-the-seat fare basis to charter, or rent an aircraft, that would provide an alternative to both, the airlines, and, private by-the-entire-aircraft charter offerings.

### SUMMARY

The system and method, of the present invention, of consolidating passengers for private aircraft, represents an entirely new, and novel solution to the problems, and inconveniences of air travel as offered by commercial airlines, and entities that offer charter aircraft to the public.

It is axiomatic that the more passengers sharing a private flight; the less the cost to each passenger. For example: Assuming the cost to charter a 10 seat jet from departure point “A” to destination point “B” is $10,000. If only one passenger rides the plane the cost per passenger is $10,000. If 5 passengers share the aircraft; the cost per passenger is $2,000, or, if 10 passengers share the aircraft; the cost per passenger is $1,000. The main attribute of the present invention, is to provide a method and system that enables passengers to share the costs of private aircraft travel.

It is another aspect of the present invention, to enable a plurality of passengers to share the benefits of chartering a private aircraft in order to make said travel more affordable.

It is another aspect of the present invention, to enable a plurality of passengers to have access to private aircraft travel without having to rent, or pay for, an entire aircraft individually.

It is another aspect of the present invention to provide an automated means for passengers to independently create their unique flight schedules, and then, find similar schedules in order to consolidate these schedules so as to share the costs of renting, or chartering an aircraft.

It is another aspect of the present invention to provide a method, and means, of enabling passengers, desirous of sharing a flight on a cost-per-seat basis, to share their schedules with others of a like mind.

It is another aspect of the present invention to allow passengers, desirous of chartering, or renting a private aircraft, a method and means of reserving a seat for that flight.

### DRAWINGS

FIG. 1 is a diagrammatic representation of a preferred embodiment of the invention.

FIG. 2 depicts a flow chart illustrating the system of the present invention operating in a preferred embodiment.

For descriptive purposes, numerals are designated for reference points.

Drawings—Preferred Embodiments

To promote clarity, specific terminology is used in describing the present invention. However, the invention is not intended to be limited to the said terms.

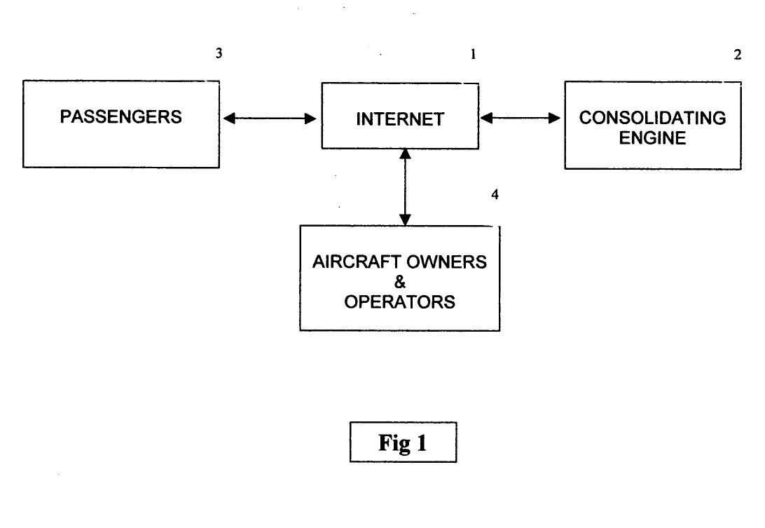

FIG. 1 illustrates the interactive relationship between passengers (3), and the present invention (2) through a computerized interactive medium, such as the internet (1).

FIG. 1 illustrates the interactive relationship between charter aircraft operators, or vendors (4), and, the present invention (2) through a computerized interactive medium, such as the internet (1).

FIG. 1 illustrates the interactive relationship between passengers (3) and charter aircraft operators, or vendors (4), and the present invention (2) through a computerized interactive medium, such as the internet (1).

Drawings—System of Invention

In a preferred embodiment of the present invention, a passenger desiring to fly on a private aircraft, and pay, only for the seat they occupy, logs in (5).

The passenger is prompted, by the system of the present invention, in the preferred embodiment, to enter a desired routing, and other pertinent information. The system of the present invention terms this data collectively as: a flight schedule (10).

Said flight schedule's (10) parameters includes: date and time of departure location, date and time of destination location, and the number of passengers. In a preferred embodiment designated departure can either be an airport, a city, or a region. Likewise the destination can either be an airport, a city, or a region. The designated depature location and the designated destination location, need not be of the same type. For example, the designated departure location may be a city, while the destination may be entered as an airport.

In another preferred embodiment the passenger may be prompted to supply additional information (10) such as a preferred departure location and/or a preferred date and/or a preferred time.

In another preferred embodiment the passenger may be prompted to rank additional information (10) in order to offer said passenger a more perfect match. For example: Assume a ranking scale of: 1 to 5. Where “1” is regarded as an imperative necessity, and “5” only of moderate relevance. Said passenger is prompted, by the system of the present invention, to rank airports in a region.

In another preferred embodiment, the system of the present invention can be programmed to match said rankings in terms of airports, cities, date and time vis-à-vis the passengers' schedule inputted (10).

In another preferred embodiment, a travel-time display, supplies the passenger with travel-time-to-destination data enabling the passenger to select, departure locations and/or destinations dates and/or times, using more appropriate data, to achieve exactitude. Said data is required by said passenger to plan their arrival-at-destination affairs, plus, onward legs, if, and when, required. In another preferred embodiment of the present invention, said travel-time display could be ranked.

In another preferred embodiment, access to a calendar, and map feature may be displayed, to enable the passenger to more conveniently select departure locations and/or destinations dates and/or times.

In another preferred embodiment, access to an aircraft profile feature could be displayed, to permit the passenger to choose an aircraft type and size.

In the preferred embodiment, the system of the present invention stores said flight schedule (10) into inventory, and, renames it: open flight schedule(20). Said inventory of open flight schedules is maintained in a dynamic relational data base (20).

The system of the present invention, in the preferred embodiment, performs a search, sort, and match (15) of said, stored open flight schedules, in terms of; departures, destination, date and time.

In another preferred embodiment of the present invention, the result of the said search (15), could be further evaluated in terms of the ranking.

In the preferred embodiment of the present invention, all open flight schedules in inventory are displayed to the passenger (20).

The system of the present invention, in another embodiment, maintains a data base of all open flight schedules (20). Each open flight schedule shows the number of passengers presently booked for each open flight schedule; the passenger-capacity of the aircraft; and, the number of vacant seats still available. The cost per passenger is also displayed. This cost is calculated by dividing the total cost of the flight schedule, by the present number of passengers booked on said flight schedule.

In the another embodiment of the present invention, said data base (20) contains a data link to vendors, or operators of private aircraft-for-charter. Said vendors' data base supply the information detailing: type, passenger capacity, travel-time, and, total cost, inclusive of all taxes, to provide said aircraft for a defined trip, as well as, any other pertinent information needed by passengers, when, said passengers create their flight schedule (10). Said information is readily available from many sources in the public domain. Further, said information is continually updated, so as to reflect, current availability, and cost, of aircraft for charter.

In the preferred embodiment, the passenger is shown, by the system of the invention, all open flight schedules (20) in terms of designated criteria. For example, the passenger is given access to view, all open flight schedules departing a particular city on a particular day, or all flight schedules arriving at a particular airport at a particular time, or all open flight schedules for a particular day, or any permutation thereof.

In another preferred embodiment passenger can access, and view, by the system of the present invention, all open flight schedules (20) in terms of parameters: airport, city or region, or the ranking thereof.

In the preferred embodiment of the present invention, the passenger is offered a choice by the system of the present invention (25). Said passenger may either accept or reject the proposed open flight schedule.

In the preferred embodiment, if the passenger accepts the proposed open flight schedule (25), the system of the present invention, adds, or books, said passenger on to the said open flight schedule, and, displays the new cost per passenger (30) and, the new, increased passenger load.

The system of the present invention, in the preferred embodiment, changes the status of said passenger who accepts (25) to: “booked.”

In the preferred embodiment, the system of the present invention updates the open flight schedules (30) which reflects: the increased number of passengers now booked on said open flight schedule, and, the cost per passenger is amended to reflect the increased occupancy.

However, if the passenger rejects (25) the proposed schedule, in the preferred embodiment, said passenger's open flight schedule becomes a new additional open flight schedule (80). This, said open flight schedule is maintained as inventory by the system of the present invention (40), and becomes an additional open flight schedule of the inventory displayed (20) to future passengers who might log on (5).

In the preferred embodiment, the system of the present invention interacts in real time with passengers. As certain limiting thresholds (45) (50) (55) are reached, the passengers who are booked on an open flight schedule (30) have to be notified.

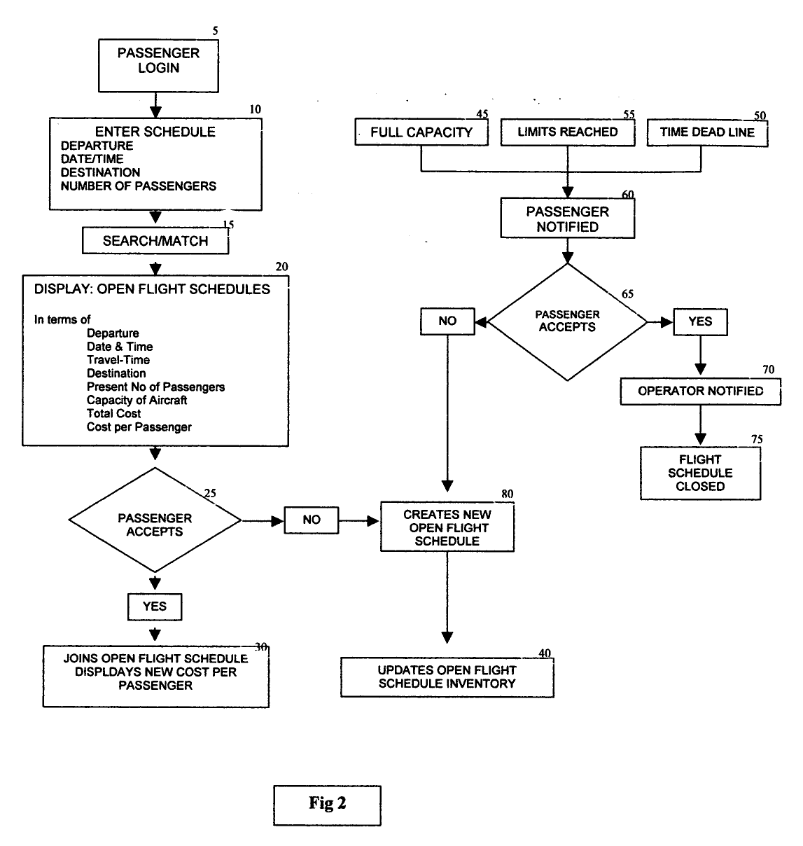

Said limiting thresholds are: a) full occupancy of the aircraft, b) deadline, or lead time before actual flight, and, c) any other factors triggered, or events transpired, which then mandate a decision by the booked passenger. FIG. 2 labels these as (45) (50) (55) respectively.

Upon any of the afore mentioned limits being triggered, in the preferred embodiment, the system of the present invention notifies the booked passenger (60). Said notification could be via email, telephone, or any interactive means.

The system of the present invention, in the preferred embodiment, offers the booked passenger a choice (65). In the preferred embodiment the passenger can either accept, or reject the choice offered in (65). Said communication by said passenger could be via email, telephone, or any interactive means.

When all the booked passengers who have booked on a particular open flight schedule accept the choice offered (65), the system of the present invention, in the preferred embodiment, performs the following: a) changes the status of the flight schedule from “open” to “closed” (75), and b) notifies the vendor, or operator of the aircraft, of an order to charter an aircraft (70).

The system of the present invention, changes the status of said booked passenger who accepts (65) to: “committed.”

In another preferred embodiment the system of the invention notifies (70) the said vendor so as to convey the details of departure, and destination as stipulated by the closed flight schedule. As well as supply said operator with a passenger manifest. The system of the present invention also facilitates billing and payment for the aircraft.

In another preferred embodiment, the system of the present invention bills each individual committed passenger of a closed flight, for their portion of the flight (75). Said passengers may pay by any automated, or previously agreed methods.

In another preferred embodiment the system of the present invention instructs the vendor, or operator of the flight, to issue each committed passenger a notification of the itinerary of the flight. This notification, or ticket, is subsequently conveyed to each committed passenger.

However, if a passenger rejects the open fight schedule (65). The booked passenger is prompted by the system of the present invention, in the preferred embodiment to create a new open flight schedule (80).

For a variety of reasons, a limit may be reached (55) before a full complement of passengers is reached. In this case the options offered, by the system of the present invention, in the preferred embodiment, to the booked passengers (65) will be for the open flight schedule that does not have a full complement of passengers. The fare, or cost-per-seat, for the flight will be as represented in (20). It is each booked passenger's prerogative to, either, accept or reject this open flight schedule (65).

Onward legs, and return trips are treated, by the system of the present invention, as discreet open flight schedules. The system of the present invention, the consolidating engine, therefore, efficaciously processes any combinations of flight plans and itineraries.

The foregoing descriptions and drawings should be considered as illustrative only of the principles of the system of the invention. The invention may be configured in a variety of configurations, and sequences, and is not limited to the configuration, or sequence of the preferred embodiment. Therefore, it is not desired to limit the invention to the specific examples disclosed, or the exact configuration, or sequence described. Rather, all suitable modifications and equivalents may be resorted to, falling within the scope of the invention.

Drawings—Conclusin, Ramificaton, & Scope of Invention

The purpose of the invention is to make the opportunities, and conveniences, associated with private aircraft travel, economically affordable to a plurality of travelers. The system of the present invention, the consolidating engine, achieves this simply, and efficiently by consolidating various itineraries.

While the foregoing narrative contains many specificities these should not be construed as limitation on the scope of the present invention, the consolidating engine, but rather an exemplification of one preferred embodiment thereof. Many other embodiments, or variations are possible:

For example: In FIG. 1, the Internet (3) could be any form of interactive medium that facilitates rapid interactive exchange of data between a plurality of individuals;

For example: In FIG. 1, Charter Aircraft Operators (4) could be any vendor of a service or product;

For example: In FIG. 1, Passengers (3) could be any user, or potential user, of said service or product. Further, said user need not be a member of the general public, but could well be a member, or an associate, of a private club or sect.

Further, said service, or products, could be any form of craft, container, or vessel that transports people, or cargo. Further, said service, or products, could, as well, be any commodity, not necessarily in the field of transportation. Said commodity being any commodity that is beyond the economic reach of one individual, but by using the present invention, the consolidating engine, said individual could share the benefits of said commodity by sharing the commodity with other like-minded individuals. Examples: renting of a stadium, or other structure; leasing a recreation area; hiring a symphony orchestra.

Accordingly, the scope of the present invention, the consolidating engine, should be determined not by the embodiments illustrated, but by the appended claims.

What is claimed is:

1. A method to consolidate a plurality of passenger schedules, comprising the steps of:
(a) receiving a schedule from a passenger via an interactive media, and
(b) matching all schedules, stored in a data base of schedules, in terms of said passenger's schedule's parameters,
(c) displaying similar schedules to said passenger,
(d) offering passengers a choice of; acceptance, or rejection, to joining of said schedule,
rejecting said choice,
adding said passenger's initial schedule to an inventory of stored schedules, in said database,
accepting, said choice,
renaming said schedule as open schedule,
adding said passenger to accepted open schedule,
renaming said passenger as booked passenger,
(e) updating the inventory of said open schedules stored in data base,
(f) notifying, via interactive media, all booked passengers on said open schedule, of
reaching limits,
delineating said limits, as,
being full capacity of aircraft achieved,
being, deadline time before departure, or,
being, any other events, once triggered, mandate said booked passengers' action, whereby said passenger is promptly made aware of impending events regarding their itinerary,
(g) offering, said booked passengers, a choice of, either accepting, or rejecting, said open schedule,
rejecting said choice,
prompting booked passenger to submit new schedule,
accepting said choice,
renaming, said open schedule, closed schedule,
renaming, said booked passenger, committed passenger,
(h) notifying, all said committed passengers of aggregated itinerary, whereby completing the process, which facilitates, each of the said committed passengers, the ability to travel their personal itinerary and also, share in the total cost of the private charter flight.

2. The method of claim 1, wherein the step of, receiving a schedule, further comprising the step of:
(a) receiving said passenger's preferences of itinerary parameters,
(b) ranking said preferences,
(c) matching said rankings,
(d) displaying travel-time-to-destination, whereby a more precise match of open schedules can be achieved, and, to facilitate improved planning for the passenger.

3) The method of claim 1, wherein the step of, receiving a schedule, further comprising the step of:
(a) displaying a calendar feature,
(b) displaying a map feature, whereby aiding the passenger to choose a departure, and, a destination airport.

4) The method of claim 1, wherein the step of, receiving a schedule, further comprising the steps of:
displaying an aircraft size, and type, whereby aiding passenger to make an informed choice.

5) The method of claim 1, wherein the step of, matching schedules, further comprising the step of:
(a) evaluating said schedules,
(b) ranking said schedules, whereby a closer approximation of open schedule, to the passenger's schedule can be accomplished, and, to facilitate improved planning for the passenger.

6) The method of claim 1, further comprising the step of linking to a vendor, or operator, of aircraft appropriate to performing an actual flight of the schedule.

7) The method of claim 6, wherein the step, linking, comprises of:
(a) displaying passenger capacity of aircraft,
(b) indicating total cost of flying said schedule in said aircraft,
(c) calculating the cost per booked passenger, whereby said passenger is shown the cost for travel in terms of the booked passengers.

8) The method of claim 1, wherein the step of, displaying open schedules, further comprising the step of:
accessing said schedules in terms of any of said schedule's parameters,
whereby aiding the passenger to book a schedule.

9) The method of claim 1, wherein the step of, notifying all booked passengers, further comprising the step of:
(a) notifying, via interactive media, said booked passengers, of, a limit being reached before a full complement of passengers is reached,
(b) displaying total cost for fight,
(c) displaying current cost, per booked passenger, whereby the booked passenger may then elect to accept, said open flight, even though the cost per passenger has not been optimized because the aircraft is not full.

10) The method of claim 1, further comprising the step of:
(a) notifying the vendor of impending charter,
(b) supplying said vendor with itinerary of closed schedule,
(c) supplying said vendor with passenger manifest,
(d) facilitating payment for said charter,
(e) instructing vendor to issue tickets to committed passengers, whereby facilitating the travel process.

11) The method of claim 1, further comprising the step of: billing each committed passenger for their portion of closed schedule.

12) The method according to 1, wherein steps (a)-(h) are repeated for a plurality of schedules, whereby the system of the invention, efficaciously processes onward legs, and return trips.

13) The method of claim 1, wherein the database of open schedules is a computerized database accessible via computerized interactive networks.

14) The method of claim 14, wherein the schedule information is inputted by the passenger via a computerized interactive network.

15) A system of combining the schedules of a plurality of passengers of private aircraft, and, pricing said aircraft, and, reserving said aircraft comprising:
(a) a data storage system accessible via a distributed network,
(b) means for receiving schedule information from at least one passenger including at least one departure location, and at least one destination location,
(c) means for linking to at least one charter operator's information data base,
(d) means for sorting, searching and matching a plurality of open schedules,
(e) means for determining a price per passenger for at least one identifiable schedule,
(f) means for an interactive communication with at least one passenger,
(g) means for accepting said passenger's commitment,
(h) means for transmitting consolidated itinerary information to said charter operator.

16) A computer program product comprising: a computer readable medium having, computer readable program code, embedded therein, that facilitates, processing a request from at least one user of a commodity, request having use-of-commodity information, the computer program product comprising:
(a) computer readable program code configured to cause a computer to receive the user's request from a user,
(b) computer readable program code configured to cause a computer to automatically aggregate all user's requests,
(c) computer readable program code configured to cause a computer to, display said user's request in a hierarchal fashion,
(d) computer readable program code configured to cause a computer to, add said user to a users' request previously stored,
(e) computer readable program code configured to cause a computer to, store, and keep track of user's requests, until a predefined event is reached,
(f) computer readable program code configured to cause a computer to, communicate with said users, informing said users of said event,
(g) computer readable program code configured to cause a computer to accepting said user's decision,
(h) computer readable program code configured to cause a computer to, complete procurement arrangements of said users' commodity, whereby facilitating a plurality of users to share the use of said commodity, as well as amortize the cost-of-use of said commodity among said users.
